(19) United States
(12) Patent Application Publication
(10) Pub. No.: US 2004/0018267 A1
(43) Pub. Date: Jan. 29, 2004

(54) Method for taking out a molded product and apparatus for the same

(75) Inventors: Yoshitaka Ohno, Kanagawa-Ken (JP); Tishio Kagitani, Kanagawa-Ken (JP); Sohei Masaki, Kanagawa-Ken (JP); Shoji Abe, Kanagawa-Ken (JP); Katsumi Kohama, Saitama-Ken (JP)

Correspondence Address: TAROLLI, SUNDHEIM, COVELL & TUMMINO L.L.P., 526 SUPERIOR AVENUE, SUITE 1111, CLEVEVLAND, OH, 44114, US

(73) Assignees: Yachiyo Industry Co., Ltd; The Japan Steel Works, Ltd.

(21) Appl. No.: 10/408,023

(22) Filed: Apr. 4, 2003

(30) Foreign Application Priority Data
Jul. 22, 2002 (JP) 2002-212241

(51) Int. Cl. B29C 47/00

(52) U.S. Cl. 425/532; 425/438

(57) ABSTRACT

The present invention relates to a method for taking out a molded product and an apparatus for the same. Use a chucking fixture (60) with claws (67a, 67b) which may clamp a upper extending portion (52A) of the molded product (52), is mounted on a robot arm (52a) of a taking out robot (55) and then said molded product (52) can be taken out by force produced by the molds (11) for separating the product (52) from the molds (11) through making chucking arms (66a-66d) with claws (67a, 67b) be in a state of moving along the horizontal direction without to bring load to between the product (52) and the upper extending portion (52A) thereof.

### FIELD OF THE INVENTION

The present invention relates to a method for taking out a molded product and an apparatus for the same, more particularly, to a novel improvement in that a molded product can be conveyed to next procedure reliably through the extending portion of the product being higher precisely clamped and cooled by force by a chucking fixture having a cooling means, at the same time, there is no extension on the extending portion of the molded product during the transportation to the next procedure using only one chucking fixture because of the movement of the chucking and the utilization of a floating block mechanism.

### BACKGROUND OF THE INVENTION

As such a conventional method and apparatus for taking out a molded product, two examples can be given. One of both examples is disclosed in JP-A-8-238632 Publication as first conventional example and in JP-A-11-165348 Publication as second conventional example.

FIGS. 5 to 9 show first conventional example.

That is, several chuck pieces 24, mounted in a frame 1 in which it can reciprocate, are chucking a upper extending portion 52A of a upper portion of a molded product formed in mold 11 which is shown in FIG. 7 and kept a force separating the molded product 52 from the mold 11 each other in a case of opening the mold 11, and then the separated molded product 52 has been hanged by respective chuck pieces 24.

Said molded product 52 comprising a upper extending portion 52A, a main body 52B and a lower extending portion 52C is moved from a chuck position X to a molded product taking out position Y in a manner which the upper extending portion 52A of the product is chucked and hanged by respective chuck pieces 24, and then the molded product 52 will be transported to a next procedure in the taking out position.

In a case of which have been transported the molded product to the next procedure, the molded product will be moved to above a shoot 70 in a state of using a upper pinch 60 to clamp the upper extending portion 52A thereof and falls down on the shoot 70 as shown FIG. 9, and then the molded product is transported to the next procedure after cutting off the upper and lower extending portion 52A/52C by hands.

FIGS. 10 to 16 show second conventional example. In FIGS. 10 to 16, symbols 1 and 2 denote blow molding units, respectively. The blow molding units 1 and 2 have identical structures. Each of the blow molding units land 2 comprises carriages 1a and 2a, each of which has an end portion supported on a base plate 9 by the corresponding one of swinging fulcrums P1 and P2 shown in FIG. 10 so as to freely swing. Blow molding molds hand 12 are provided on the carriages 1a and 2a, respectively.

Swing-driving devices 21 and 22 can be constituted by double acting cylinders which connect the base plate 9 and the carriages 1a and 2a respectively. By Swing-driving devices 21 and 22 to take the swinging fulcrums P1 and P2 as centers by reciprocating Swing-driving, the blow molding molds 11 and 12 provided on the other end sides of the blow molding units 1 and 2 occupy later on descriptive of common receiving position A, detaching positions B1 and B2 and avoiding positions C1 and C2. It is also possible to construct the swing-driving devices 21 and 22 with the aid of a motor as a rotary driving power source, a reducing gear device and the like. By forward or reversedly rotating the gears taking as their centers at the swinging fulcrums P1 and P2 of the carriages 1a and 2a, the blow molding units 1 and 2 can be reciprocally swung taking the swinging fulcrums P1 and P2 as centers.

Each of the blow molding molds 11 and 12 comprises mold components 11a and 11b, 12a and 12b. The mold components 11a and 11b can reciprocate between an open state in which both of the mold components 11a and 11b separate from each other and a close state in which they contact each other. The mold components 12a and 12b can also reciprocate between the open state and the close state. Mold cavities are formed in facing planes of the mold components Ha and 11b, 12a and 12b, and an outline of the cavities in the close state corresponds to an external shape of the freely expanding hollow parison 44 shown in FIG. 1 by increasing its internal pressure. The mold components 11a, 11b, 12a and 12b of the blow molding molds 11 and 12 are made to reciprocate by open-close devices 13 and 14 (clamping device), which perform an open-close operation.

Actually, as shown in FIGS. 10 and 11, an end portion of the carriage 1a of one blow molding unit 1 is supported on the base plate 9 by the swinging fulcrum PI so as to freely swing. A rolling element 1b provided at the other end portion of the carriage 1a is allowed to freely roll on the base plate 9. Moreover, supports 15 and 16 are disposed on the outside of the mold components Ha and lib, and connected by tie rods 17 and 18. The tie rod 17 disposed at the lower position is provided at the position where it does not hinder the receipt of the parison 44. Moreover, a support 25 is fixed behind one mold component 11a. An open-close device 13 is disposed between the supports 25 and 16 positioned on one end portion side.

By an operation of the open-close device 13, the mold components 11a and 11b are separated from each other whereby a mold opening can be performed and contacted with each other whereby a mold closing can be performed. It should be noted that a pair of the mold components 11a and 11b are driven by a synchronous apparatus (not shown) synchronizing them. At this time, the supports 15, 16 and 25 are moved smoothly by rolling the rolling elements 19 shown in FIG. 10 on the carriages 1a and 2a. The other blow molding unit 2 also has a similar structure, and the same function portions as blow molding unit 1 are denoted by the same symbols as shown in FIG. 11. On the other hand, an extrusion device 41 is disposed above the blow molding units 1 and 2 as shown in FIG. 10. The extrusion device 41 is supported on the base plate 9 and fixed thereto through a supporting rod 49 and a supporting stage 48, and comprises a common extrusion head 4. Generally, the extrusion head 4 can continuously supply the parison 44. The extrusion device 41 may also be constituted such that a plurality of extrusion devices 41 are connected to the extrusion head 4. In the case where the plurality of extrusion devices 41 are connected to the extrusion head 4, also the parison 44 hanging down from the extrusion head 4 in the form of tube takes a multi-layer structure formed of a thermally softened thermoplastic material which is extruded from each extrusion device 41.

By individually driving the blow molding units 1 and 2 so as to reciprocally swing by the swing-driving devices 21 and 22, the centric positions of the parting planes of the mold components 11a, 11b, 12a and 12b of the blow molding molds 11 and 12 can be moved between the common receiving position A for receiving the parison 44 and the detaching positions B1 and B2 for detaching the expanded hollow article from blow molding molds 11 and 12 and the avoiding positions C1 and C2 for avoiding interference with other blow molding units 2 and 1. Therefore, the receiving position A, detaching position B1 and avoiding position C1 are positioned on the arc with one swinging fulcrum PI as center, and the receiving position A, detaching position B2 and avoiding positions C2 are positioned on the arc with the other swinging fulcrum P2 as center. It should be noted that the parison 44 received in the receiving position A is expanded by the blow molding so as to form the hollow article before the blow molding molds 11 and 12 reaching the avoiding positions C1 and C2 after passing through the detaching positions B1 and B2 from the receiving position A.

Here, the swinging fulcrums P1 and P2 are placed keeping the following positional relationship. Specifically, in the plane view shown in FIG. 11, the lines passing through the extrusion head 4 and crossing at a right angle are denoted by the reference symbols X and Y, and the centric axis line of the extrusion device 41 in which one or two extrusion devices are disposed on the straight line is made to be coincident with the line X. Accordingly, the line X is in agreement with the longitudinal direction of a support stage 48. The swinging fulcrums P1 and P2 are disposed symmetrically on both side of the line Y, and the detaching positions B1 and B2 and the avoiding positions C1 and C2 are positioned at the same external side with respect of the support stage 48, in other words, they are positioned below the support stage 48 in FIG. 11. As a result, when viewed from above, the detaching positions B1 and B2 and avoiding positions C1 and C2 of the respective blow molding molds 11 and 12 of the two blow molding units 1 and 2 are positioned on one side of the centric axis line X of the extrusion device 41, that is, they are positioned at lower side of the support stage 48 in FIG. 11. Thus, by the comparatively small swinging movement of the blow molding units 1 and 2, the receiving position A and the detaching positions B1 and B2 can be taken, and a pair of detaching positions B1 and B2 can be disposed closely to each other. At the same time, it will be possible to prevent a upward detaching operation of the hollow article by the support stage 48 from breakdown. Therefore, in the case where the three or more extrusion devices 41 are connected to the extrusion head 4, they are disposed behind the line X, that is, they are disposed at the upper portion of FIG. 11.

Next, an operation of the first embodiment will be described. At the beginning, as shown in FIG. 11, it is assumed that the blow molding mold 11 of one blow molding unit 1 is occupying the receiving position A, and the blow molding mold 12 of the other blow molding unit 2 is occupying the avoiding position C2. In this situation, since the blow molding mold 11 of one blow molding unit 1 is opened and the parison 44 continuously extruded downward from the extrusion head 4 hangs down between the mold components 11a and 11b, the open-close device 13 is driven so that the blow molding mold 11 is closed. Thereafter, one blow molding unit 1 is driven swingablely by the swing-driving device 21, so as to pass through the detaching position B1 to occupy the avoiding position C1 as shown in FIG. 12. The parison 44 which reached the avoiding position C1 is expanded by air and molded to, for example, a shape of fuel tanks for use in cars. Thereafter, in the avoiding position C1, the parison 44 expanded to the shape of the hollow article is cooled in the blow molding mold 11.

Subsequently, the other blow molding unit 2 is driven swingablely by the swing-driving device 22 as shown in FIG. 13, so that the blow molding mold 12 is made to occupy the detaching position B2. Since the parison 44 has already been received by the blow molding mold 12 of this blow molding unit 2 as will be described later, the solidified part (flash) of the parison 44, which overflows from the blow molding mold 12 occupying the detaching position B2, is seized by the clamping device 50 shown in FIG. 12, and taken out together with the hollow article. The clamping device 50 comprises a main unit 51 driven in the direction of the line Y by a driving device located outside as shown in FIG. 12, an extending portion 52 extending to both sides of a direction which is perpendicular to the main unit 51 (the direction of the line X) from a front end of the main unit 51, and seizing portions 53 and 54 provided on both ends of the extending portion 52. At least one of the seizing portions 53 and 54 can be rotated, and the hollow article of the blow molding mold 11 seized by one seizing portion 53 and the hollow article of the blow molding mold 12 seized by the other seizing portion 54 are made to be directed to the same direction, and both hollow articles can be taken out downward as shown in FIG. 12. The hollow articles taken out downward in FIG. 12 are released from seizing by the seizing portions 53 and 54 and transported to the outside by a belt conveyer (not shown). If the hollow article was detached from the blow molding mold 12, the other blow molding unit 2 is driven swingablely by the swing-driving device 22 as shown in FIG. 14, and moved to the receiving position A in its mold opening state. Since the parison 44 continuously extruded downward from the extrusion head 4 is received between a pair of the mold components 12a and 12b of the blow molding mold 12, the mold components 12a and 12b are closed by the open-close device 14.

Subsequently, the other blow molding unit 2 is driven swingablely by the swing-driving device 22 as shown in FIG. 15, so that the blow molding unit 2 is made to pass through the detaching position B2 to occupy the avoiding position C2 in original state of the mold close state. Air is blown into the parison 44 in the blow molding mold 12 which occupies the avoiding position C2 and is similar to foregoing one blow molding mold 11, so that the parison 44 is molded to a hollow article of a shape of a fuel tank for cars. At the same time, the parison 44 molded to a hollow article is cooled. While the blow molding mold 12 is occupying the avoiding position C2, one blow molding mold 1 in which the cooling of parison 44 has proceeded in the avoiding position C1 is driven swingablely by the swing-driving device 21, and moved to the detaching position B1 in original state of the mold close state. The solidified part (flash) of parison 44 is seized by one seizing position 53 of the clamping device 50 in the blow molding mold 11 which occupies the detaching position B1, and the mold components 11a and 11b are separated from each other by the open-close device 13. At the same time, the main unit 51 of the clamping device 50 is driven in the direction of the line Y, so that the hollow article is taken out to the outside. This situation is illustrated in FIG. 16.

Thereafter, one blow molding unit 1 is driven swingablely by the swing-driving device 21, and moved to the receiving position A in mold open state. Since the parison 44 extruded downward continuously from the extrusion head 4 is received between a pair of mold components 11a and 11b of the blow molding mold 11 which has occupied the receiving position A, afterwards, a plurality of hollow articles can be formed by the blow molding by reciprocally repeating the similar operations. As described above, by sequentially giving the receiving position A, the detaching positions B1 and B2 and the avoiding positions C1 and C2 to the pair of blow molding units 1 and 2, at the same time, the similar operations are repeated.

There are the following problems for the conventional method and apparatus for taking out a molded product by the above mentioned structure, that is, for the first and second conventional examples shown in FIGS. 5 to 9, there is a disadvantage that accuracy in position (position accuracy) for transporting the product to a next procedure by using a taking out machine reduces significantly due to the following reasons in the case of taking out a vessel such as a plastic fuel tank for use in cars (PFT) which is great in size and heavy in weight. At first, the first conventional example will be described.

(1) When the taking-out machine has held the upper extending portion at a position (X) and the molds are opened, a flexible portion of the extending portion between upper and lower extending portion and the molded product will extend due to a action of a separating force which separates the molded product from the molds (due to a complicated form, the force is necessary which separates the molded product from the molds), as a result, a chuck position where the taking-out machine clamps the molded product and a position between the molded products are changed greatly.

(2) Since the flexible upper extending portion between the chuck portion of the taking-out machine and the molded product will lengthen due to the weight of the large-scale vessel during the movement of the molded product, a accuracy of taking out the molded product will be change greatly.

(3) The accuracy in position where the molded products naturally falling down lies in a dispersive state, when the taking out machine has released the upper parison at the position (Y) so as to make the molded product naturally falling down to a stable position on a shoot shown in FIG. 9.

(4) In the case of the second conventional example, for improving productivity efficiency by using a pair of mold units, in addition to the above mentioned problem, when a molded product are taken out by utilizing a plurality of mold units, it is necessary for each of mold units to set up a taking out machine, and the molded product having extending portion and taken out by the taking out machine will be taken out at respectively different places (Y-1)(Y-2).

Therefore, the taken out molded product having extending portion is deteriorated in position accuracy due to the separating force and the weight of the molded product, the taking out position accuracy is changed significantly due to the freely falling down. It is necessary that to mount a plurality of taking out machine for improving the productivity efficiency in using a plurality of mold unites, thus automatization of the next procedure is difficult, because the molded product is dispersed in different places. Because the claws for chucking the product have not be cooled, it must take a period of time to cool the upper extending portion, so that it is difficult to obtain a short forming cycle.

In consideration of the foregoing, a object of the present invention is to provide a method and an apparatus for taking out a molded product, particularly, wherein the upper extending portion of a molded product can be clamped in higher precision by a claws of a chucking fixture having a cooling means and can be transport to next procedure reliably by the upper extending portion of force cooling, at the same time without the extension of the extending portion of the molded product, the molded product having weight can be transport to the next procedure by the using only one chucking fixture because of the movement of the chucking fixture and the utilization of a floating block mechanism.

### SUMMARY OF THE PRESENT INVENTION

A method for taking out a molded product according to the present invention is a method such that a parison hanging down from a extrusion head flows into a mold and forms a molded product, and then the molded product is taken out, wherein a chucking fixture with claws which may clamp a extending portion of the molded product and can be opened or closed freely, is mounted on a robot arm of a taking out robot and then the molded product can be taken out by a force produced by the molds for separating the product from the mold through making chucking arms be in a state of moving along the horizontal direction without any increase in load to a weight between the product and the extending portion thereof. In addition, the method according to the present invention comprises a cooling means cooling said claws The upper extending portion are cooled by the cooling means when the claws clamp the extending portion will be cooled by the cooling means in the case of clamping said extending portion. The method according to the present invention is that said molds are mounted on a first and a second blow molding units which may rotate alternately each other, and the product molded by the molds may be taken out from the first and second taking out positions both of which are different each other. A apparatus for taking out a molded product according to the present invention, which a parison hanging down from a extrusion head flows into the mold and forms a molded product, and then the product is taken out, comprises a chucking device with claws which may clamp a extending portion of the molded product and can be opened or closed freely, a taking out robot having a robot arm where said chucking device is mounted, a floating block provided on said chucking device and supporting pivotally and rotatively chucking arm with said claws and a floating shafts supporting said floating block moving along the horizontal direction on thereof; said claws are made to constitute that they are movable in the horizontal direction in a state of chucking said upper extending portion by itself. In addition, said claws are made to constitute that each of them has a cooling means said upper extending portion can be cooled by the cooling means when chucking it by the claws. Said molds are mounted on a first and second blow molding units which may rotate alternately each other, and the product molded by the molds may be taken out from the first and second taking out positions both of which are different each other.

### BRIEF DESCRIPTION OF THE DRAWING

FIG. 1 is a plane view showing an apparatus for taking out a molded product according to the present invention.

FIG. 2 is a front view of FIG. 1

FIG. 3 is a sectional view showing a chucking fixture of FIG. 1.

FIG. 4 is a sectional view along line A-A of FIG. 3.

FIG. 5 is a plane view of a conventional apparatus for taking out a molded product.

FIG. 6 is a front view of FIG. 5.

FIG. 7 is an enlarged front view showing main parts of FIG. 5.

FIG. 8 is a front view showing a molded product of FIG. 7.

FIG. 9 is a structure chart shown in state of the molded product of FIG. 8 falling down on a shoot.

FIG. 10 is a front view showing another conventional apparatus

FIG. 11 is a plane view of FIG. 10.

FIG. 12 is a plane view showing a forming situation of FIG. 11.

FIG. 13 is a plane view showing a forming situation of FIG. 11.

FIG. 14 is a plane view showing a forming situation of FIG. 11.

FIG. 15 is a plane view showing a forming situation of FIG. 11.

FIG. 16 is a plane view showing a forming situation of FIG. 11.

### DETAILED EXPLANATION OF THE INVENTION

### EXAMPLES

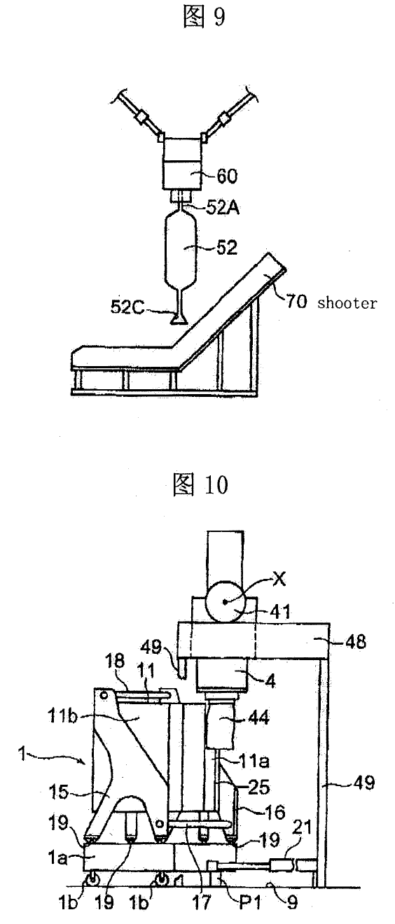

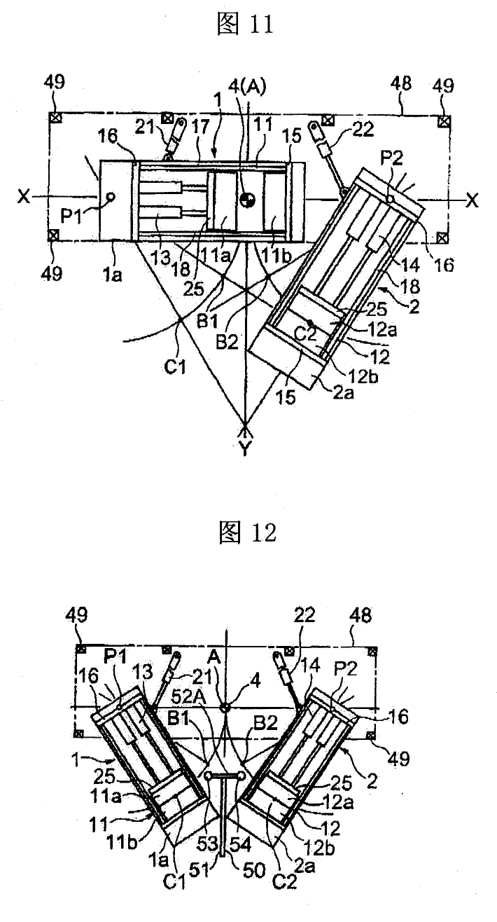

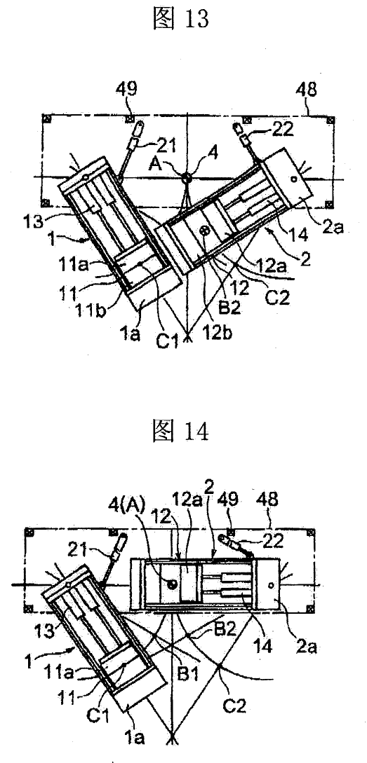

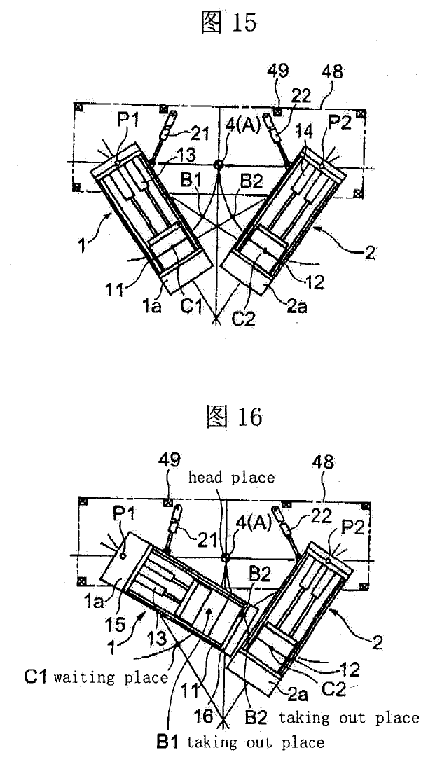

Hereinafter, the preferred embodiment of the method and the apparatus for taking out a molded product according to the invention with reference to the drawings will be described. With respect to the structure shown from the FIG. 10 to FIG. 16 as shown in the conventional example, there is only a difference on structure taking out the molded product after the product has been molded, and the other structure is completely similar, therefore, the description for them are omitted in this specification, and the different structure will be explained here with the combination of the structure shown by the FIG. 10 through the FIG. 16. The same reference symbols show the same portion or the corresponding portion as the conventional example.

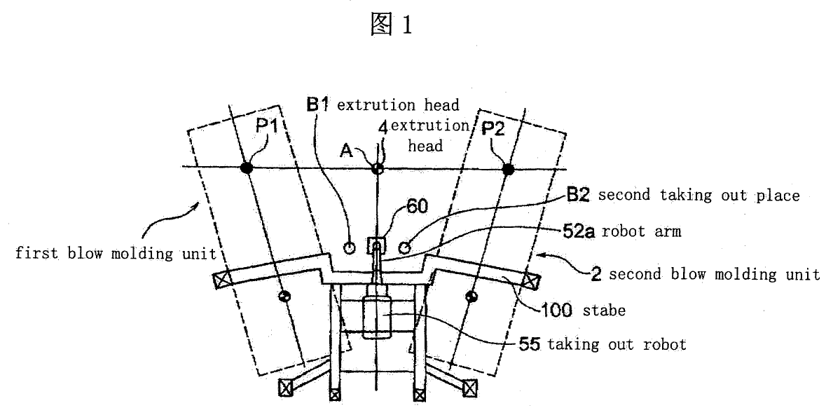

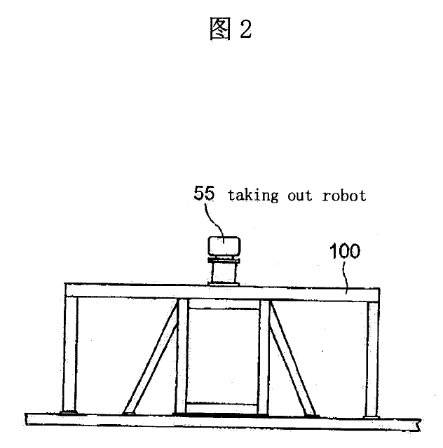

In the FIG. 1, the reference symbol 100 indicates a supporting table which is designed such that a first and a second blow molding units 1 and 2 mounted rotatively on the supporting table in a spanning state and without interference each other when they is rotating. A taking out robot 55 including a robot arm 52a, for example, which is of a vertical multi-joint type and may rotate forward the left and the right in horizontal direction, is mounted on the supporting table 100.

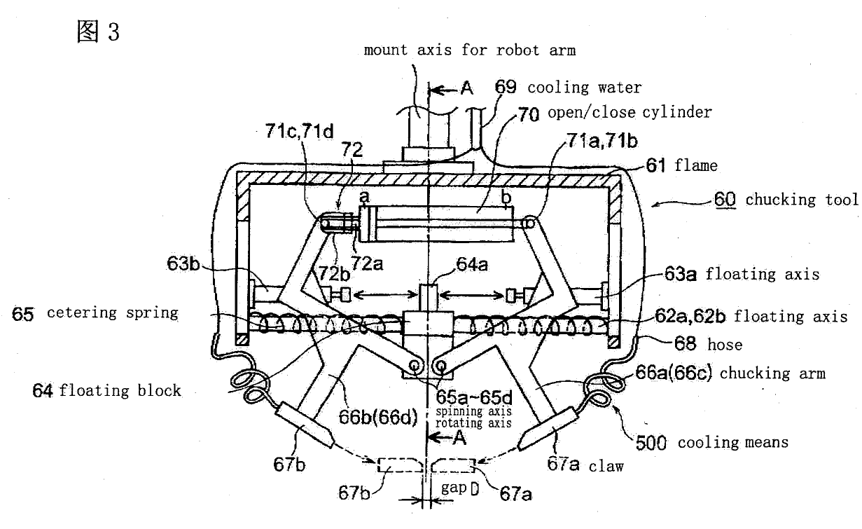

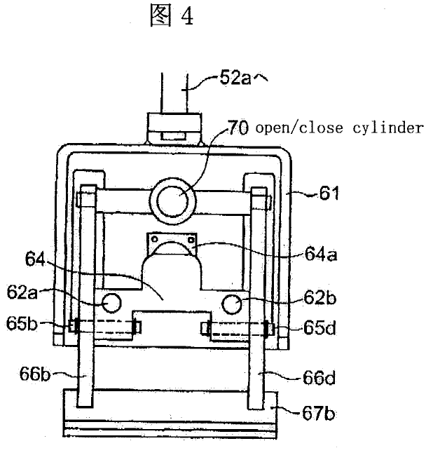

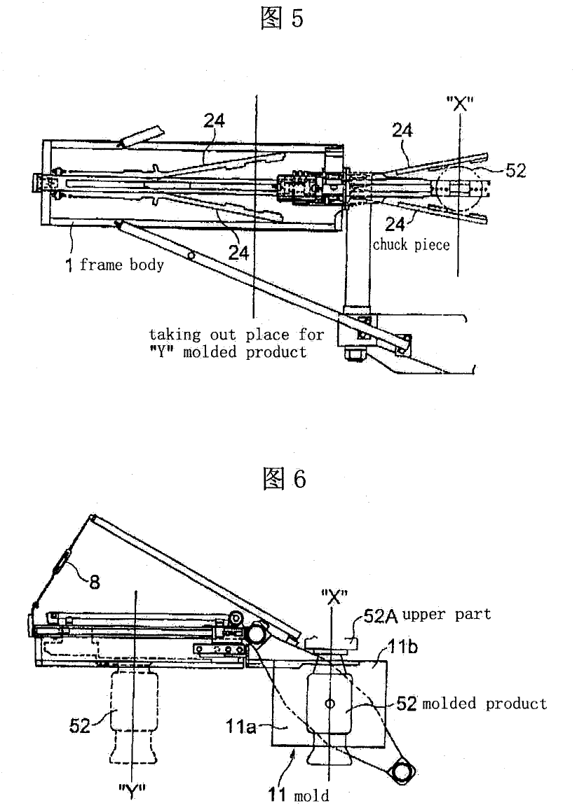

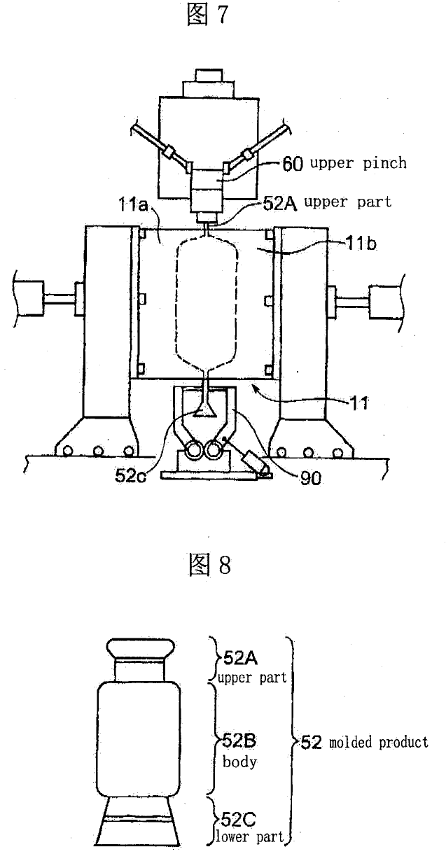

On the low portion of aforementioned robot arm 52a is provided a chucking fixture 60 (shown in FIGS. 3 and 4) which is designed such that the chucking fixture 60 may rotate forward the left and the right direction and clamp the molded product 52 at the first and the second taking out position, at the same time, and hold up the molded product 52 upward, and then rotate again and can transport to the molded product 52 on a transporting robot (not shown in figs.)

on the chucking fixture 60 is provided with a frame 61 connected mechanically to the robot arm 52 of the taking out robot 55. Two floating shafts 62a, 62b which are parallel and two positioning cylinders 63a, 63b located on the left side and the right side respectively are provided mechanically on the frame 61.

The parallel floating shafts 62a, 62b which have been assembled pass respectively through internal holes disposing in the floating block 64 which is made to slide on the floating shafts 62a/62b smoothly.

The floating block 64 is centered by four weak centering springs 65. On the floating block 64 four rotating shafts 65a [symbol] 65b [symbol] 65c [symbol] 65d are mounted. The chucking arms 66a [symbol] 66b [symbol] 66c [symbol] 66d are pivotally attached on said four rotating shafts 65a-65d respectively and may rotate around the corresponding shafts 65a-65d.

On the lower end of each of the chucking arms 66a [symbol] 66b [symbol] 66c [symbol] 66d is provided with claws 67a/67b to which cooling water 69 is provided by means of a hose 68. In order to improve the cooling ability of claws 67a/67b, aluminum material is used for it. The claws 67a/67b are provided with cooling water 69 using the hose 68 and are fully cooled. A cooling means 500 consist of the cooling water 69 and the hose 68.

An open-close cylinder 70 is disposed on a side opposite to the claws 67a/67b of the chucking arms 66 and may rotate relevant to the chucking arms and four pins 71a/71b/71c/71d.

A gap-adjusting nut apparatus 72 is mounted between the open-close cylinder 70 and one of the pins 71c/71d so as to adjust a gap between the ends of claws 67a/67b. The gap-adjusting nut apparatus 72 comprises a screw rod 72a mounted on the open-close cylinder 70a and a nut 72b mounted on the side having the pins 71c/71d and can adjust the gap D in the case of closing slaws 67a/67b, by means of adjusting the length of the screw rod 72a by rotating the nut 72b.

When air is provided to an “a” port of the open-close cylinder 70, each of these arms operate to close the claws 67a/67b on front end of the arms. When air is provided to a “b” port of the open-close cylinder 70, these arms operate to open the claws 67a/67b on front end of the arms.

In the following, an operation will be described. At first, a lower pinching means 90 shown in the drawing 7 clamps the lower end of the cylinder parison having a determined length on a parison-receiving position “A” where the extrusion head is located (completely sealing the whole width). Thereafter, a stream of thin air is blown from the hole of center of the extrusion head 4 so as to expand the parison slightly (pre blow), thereby closing completely the blow molding mold 11a/11b and then a certain pressure air is blown into the internal portion of parison so as to form of the internal surface of the mold 11. Then, the blow molding unit 1 is moved to the avoiding position after cutting the parison between the extrusion head 4 and the blow molding mold 11.

In this moment, the parison is clamped firmly by the blow molding mold 11, there is a upper extending portion 52A which is revealed from the blow molding mold 11 on upper portion of the blow molding mold 11. In addition, the middle portion of the parison has two parts, one of which is formed in the blow molding mold and another is clamped by the blow molding molds at the upper and the lower thereof and there are a portion clamped by the lower pinching mean 90 and a portion is revealed from the blow molding mold, on lower portion of the blow molding mold.

Then, the first blow molding unit 1 is moved to the taking-out position B1 after prescriptive duration of cooling at the avoiding position C1. With The claws 67a/67b of the chucking fixture 60, which is mounted on front end of the taking out robot 55 provided on the supporting table 100, the upper extending portion 52A which is revealed from above the first blow molding mold 11, that is, uppermost portion of the first blow molding mold 11 is closed and fallen down in taking out robot 55 is standard controlled, and a suitable gap between claws 67a/67b is hold and the upper extending portion 52A is caught and cooled.

The suitable gap between the claws 67a/67b is such a gap that there is no extension between the molded product 52 and the extending portion 52A clamped by the claws 67a/67b, when the molded product 52 with upper and lower extending portion is taken out from the inside of the molding mold 11 and transported on the transporting robot (not shown). Each of the claws 67a/67b is made to constitute that it can be moved forward the right and left directions, that is, forward horizontal direction by means of the floating block 64 in a state of clamping the extending portion 52A.

When the blow molding mold 11 of the first blow molding unit 1 is opened in a state of the extending portion 52A is caught by the claws 67a/67b, lower extending portion is fixed by the lower pinching means 90, when the blow molding mold 11 performs an opening operation, the molded product 52 with upper and lower extending portion will be separate from the blow molding mold 11 each other, but a force is required for separating the molded product 52 from the mold 11 according to the shape of the inside of the mold. The separating force is occurred in a direction on which the blow molding mold is operating.

At this time, the positioning cylinders 63a/63b provided in the chucking fixtures 60 of taking-out robot 55 make the floating block 64 to be in a free state as shown in the FIG. 3. Therefore, the upper extending portion is caught by the claws 67a/67b whose force pulling away the product and the upper and the lower extending portion thereof acts on any of each of mold portions 11a [symbol] 11b of the mold 11 as shown drawing 7 by means of the separating force, the claws 67a/67b and the floating block 64 move in a direction on which mold 11 and a separating force occurs on the floating shafts 62, as a result, there is no extension between the product and the upper extending portion thereof. When the separate force occurs during the opening of the mold 11 in a state of clamping the lower extending portion with the lower pinching means 90, the molded product is separated from the molds each other without any extension between the lower extending portion and the product. When the opening operation of mold 11 has finished at the end of separation, the positioning cylinders 63a/63b mounted in chucking fixtures 60 come into action and place the floating block 64 at its center.

Then, it shall be noted that the lower pinching means 90 performs an open-operation so as to loosen the lower extending portion, and then the taking-out robot 55 moves on the determined rails and stops on the transporting position where the molded product with the upper and lower extending portion is placed on the transporting robot (not shown in figs.), finally, the claws 67a [symbol] 67b of the chucking fixtures 60 of the taking-out robot 55 move apart from each other. Therefore, the taking out robot 55 according to standard control is came back to the determined position which is the middle position between the taking out positions B1\B2 without interference with each of the blow molding units 1/2 etc.

And then, when the second blow molding unit 2 stopped on the taking out position B2, the taking-out robot 55 performs an operation similar to the first blow molding unit 1 and takes out the molded product 52 and transport the molded product with upper and lower extending portions to the above described transporting robot. The method and apparatus for taking out a molded product according to the invention can obtain the following effect with the aid of the above mentioned structure.

That is, in order to keep constantly a accuracy in the position between the upper extending portion and the molded product on front end of the taking-out robot, the present Invention is provided with holding the mechanism and the claws which may keep a thickness clamping the upper extending portion by the chucking fixture at a certain thickness and cool the upper extending portion, and also having the floating block mechanism on which no acted the separate force of the mold, thereby may keep the constantly relative position between the product and the upper extending portion thereof. In addition, because the molded product can be precisely transported to the predetermined position on the transporting robot from mold stopped on taking-out position, using the rotary units and the supporting table provided on a position where the table do not interfere with the rotary units and the taking-out robot which is disposed on the supporting table and with chucking fixture for taking out, the molded shape of the product can keep constantly. The shape of the upper and lower extending portion which is cut off and available again also keep constantly. Otherwise, because the automatization and unmanned operation of a series of procedures can be realize, thereby a kind of products of high quality and having no dust can be produced, thereby It Is possible to reduce the cost of the products significantly.

What is claim is:

1. A method for taking out a molded product, a parison hanging down from a extrusion head (4) forms as a molded product (52) in molds (11) and then the molded product (52) is taken out, wherein
a chucking fixture (60) with claws (67a, 67b) which may clamp a upper extending portion (52A) of the molded product (52) and can be opened or closed freely, is mounted on a robot arm (52a) of a taking out robot (55) and then said molded product (52) can be taken out by force produced by the molds (11) for separating the product (52) from the molds (11) through making chucking arms (66a-66d) with claws (67a, 67b) be in a state of moving along the horizontal direction without to bring load to between the product (52) and the upper extending portion (52A) thereof.

2. A method for taking out a molded product as in claim 1, wherein further comprises a cooling means (500) cooling said claws (67a, 67b), the upper extending portion (52A) is cooled by the cooling means (500) when said claws (67a, 67b) clamp said upper extending portion (52A).

3. A method for taking out a molded product as in claim 1 or 2, wherein said mold (11) are mounted on a first and a second blow molding units (1, 2) which may rotate alternately each other, and the product (52) molded by said molds (11) may be taken out from said first and second taking out positions (B1, B2) both of which are different each other.

4. A apparatus for taking out a molded product, a parison hanging down from a extrusion head (4) forms as a molded product (52) in the molds (11) and then the product (52) is taken out, wherein comprising a chucking fixture (60) with claws (67a, 67b) which may clamp a extending portion (52A) of said molded product (52) and can be opened or closed freely, a taking out robot (55) having a robot arm (52a) on which said chucking fixture (60) is mounted, a floating block (64) provided on said chucking fixture (60) and supporting pivotally and rotatable freely chucking arms (66a-66d) with said claws (67a, 67b) and floating shafts (62a, 62b) supporting said floating block (64) movable freely along the horizontal direction on thereof; said claws (67a, 67b) are made to constitute that they are movable freely in the horizontal direction in a state of chucking said upper extending portion (52A) by itself.

5. An apparatus for taking out a molded product as in claim 4, wherein said claws (67a, 67b) are made to constitute that each of them has a cooling means (500) and said upper extending portion (52A) can be cooled by said cooling means (500) when said upper extending portion (52A) is chucking by the claws (67a, 67b).

6. An apparatus for taking out a molded product as in claim 4 or 5, wherein said mold (11) are mounted on a first and second blow molding units (1, 2) which may rotate alternately each other, and said molded product (52) molded by said molds (11) may be taken out from a first and a second taking out positions (B1, B2) both of which are different each other.
